(19) United States
(12) Patent Application Publication
(10) Pub. No.: US 2008/0245997 A1
(43) Pub. Date: Oct. 9, 2008

(54) Molecular oscillation type powder economizer material

(76) Inventor: Jun-Zhong Hong, Taipei Hsien (TW)

Correspondence Address: BIRCH STEWART KOLASCH & BIRCH, PO BOX 747, FALLS CHURCH, VA, 22040-0747, US

(21) Appl. No.: 11/783,230

(22) Filed: Apr. 6, 2007

(51) Int. Cl. C09K 3/00

(52) U.S. Cl. 252/182.33

(57) ABSTRACT

A molecular oscillation type powder economizer material that emits far infrared rays and negative ions for use in the oil tank, auxiliary radiator or air cleaner of the motor vehicle to improve the performance of the engine and to reduce the amount of exhausted waste gas is disclosed composed of ZnO, SiO₂, CaCO₃, MgO, K₂O, Al₂O₃, rare earth metals, and trace element.

### BACKGROUND OF THE INVENTION

1. Field of the Invention

The present invention relates to an economizer for motor vehicle and more particularly, to a molecular oscillation type powder economizer material that emits far infrared rays and negative ions. When the powder economizer material is put in contact with oil molecules, air molecules, or water molecules, the powder economizer material causes each molecule group to diminish. When the frequency of the powder economizer material is in conformity with the motion frequency between the molecule groups, resonance and oscillation are produced, thereby enhancing vibration in each molecule and causing a chemical reaction so as to achieve energy saving and air cleaning effects and to enhance oxidization.

2. Description of the Related Art

Following improvement of technical standards and realization of environmental protection, people do more care about the performance of oil-based machinery. People may spend a lot of money in improving the performance of their personal transportation vehicle to save fuel oil consumption and improve the horsepower and eliminate accumulation of carbon.

Many economizers are available on the market for installation in a motor vehicle to save fuel oil consumption, to eliminate accumulation of carbon on parts, and to improve the horsepower. Consumers do care about the real effects of these economizers. Therefore, motor vehicle related manufacturers are trying hard to create new economizers that effectively save fuel oil consumption, increase horsepower, and prohibit accumulation of carbon.

Further, conventional methods of improving fuel oil mass are to add different compositions of additives to fuel oil. These additives are commercially available. However, these replacement additives that must be continuously added to fuel oil following the consumption. Therefore, it is expensive to use these additives. Further, the user must spend a lot of time in purchasing the additives and counting the amount of the additives to add.

Therefore, it is desirable to provide an economizer that eliminates the aforesaid various problems.

### SUMMARY OF THE INVENTION

The present invention has been accomplished under the circumstances in view. It is the main object of the invention to provide a molecular oscillation type powder economizer material that emits far infrared rays and negative ions for use in the oil tank, auxiliary radiator or air cleaner of the motor vehicle to improve the performance of the engine and to reduce the amount of exhausted waste gas. The powder economizer material causes the oil molecules, air molecules or water molecules passing therethrough to rearrange the structure and to separate from hydrocarbon molecules, and therefore the oil molecules, air molecules or water molecules become smaller. When the frequency of the powder economizer material is in conformity with the motion frequency between molecule groups, resonance and oscillation are produced to cause a chemical reaction with oxide materials, so as to enhance oxidization and to reduce the amount of exhausted waste gas, achieving fuel oil saving and air cleaning effects.

It is another object of the present invention to provide a molecular oscillation type powder economizer material, which is applicable to engine oil, the space between the cylinder and the piston, gear oil, brake oil, as well steering engine oil to reduce the friction coefficient and power loss, thereby improving acceleration and increasing the horsepower.

### BRIEF DESCRIPTION OF THE DRAWINGS

FIG. 1 is a schematic drawing illustration a motion between the powder economizer material of the present invention and oil molecules.

### DETAILED DESCRIPTION OF THE PREFERRED EMBODIMENT

In organic chemistry, molecular oscillation is an important subject. Some oxides will cause an electromagnetic wave absorption effect and will release energy wave after absorption of electromagnetic wave, thereby resulting in molecular oscillation. When an electromagnetic wave beam passes a medium, the medium will cause absorption, reflection, and/or transmission effects. Reflection occurs subject to the internal molecular structure and molecular oscillation frequency of the medium. As stated above, oxides absorb energy and then release energy. When a medium releases energy after absorption of energy, it causes the molecules of the medium to rotate or oscillate, and therefore the molecules jump from low energy state to high energy state. This energy absorption frequency has a great concern with the frequency of molecular oscillation or rotation, or the energy state of the electrons in the molecules, and has also a great concern with the molecular structure. This energy is usually within the wavelength range of far infrared rays. The invention explains the spectrum effect of organic structure.

Atoms are bonded together to constitute a molecule. A bond between atoms can be formed of two balls with one spring. When the two balls of this bond are stretched or bent relative to each other, an oscillation is produced, and the oscillation frequency is subject to the gravity of the atoms and the geometric structure of the bond. Like a fingerprint or infrared spectrum, every organic molecule has a specific molecular structure and absorption spectrum. The type and structure of a molecule can be examined subject to its absorption spectrum.

Actually, the atoms of certain molecules have similar rotation or oscillation frequency that is close to a certain frequency range. This frequency range is the characteristic range of the atoms or molecules. When the resonant frequency range is found out, a chemist knows the type of the molecule and its performance.

The wavelength of infrared spectrum is within the wavelength range of visible light and microwaves, i.e., about 0.7μm˜100 μm. Molecules or atoms within this wavelength range absorb infrared rays, and the absorbed infrared rays are converted into an energy that causes molecules or atoms to rotate or oscillate. Of course, the absorption frequency is subject to the mass of the molecules, the bonding force between molecules, and the geometric structure of the molecules.

The invention provides a powder economizer material that is processed by means of nanotechnical treatment. This nanotechnical treatment has atoms or molecules be reconstructed to constitute a new nanometered structure. Building blocks based on this nanometered structure are used and designed to form a new material, component, or system. The nanometered structure is within the range of 1˜100 nanometers, i.e., between molecule and submicron. This micro material structure has different physical, chemical or biological characteristics. When the base structure of a element is diminished to a nanometer range, the size of the element is greatly reduced, and a significant quantum effect is produced, and many physical properties of the element are also changed. For example, the mass becomes light, the volume is diminished, the curvature becomes greater, the surface area is increased, and the thermal conductivity and electric conductivity are enhanced. Further, the magnetism is also changed. The element also has the characteristics of large surface area/volume ratio, high density accumulation potential, and high structural composition flexibility.

A molecular oscillation type powder economizer material is comprised of ZnO, SiO₂, CaCO₃, MgO, K₂O, Al₂O₃, rare earth metals, and trace element. As stated, the powder economizer material contains photocatalysts (such as ZnO), ceramics (such as SiO₂), mineral material (such as CaCO₃), oxide materials (such as MgO, K₂O, Al₂O₃). Further, molecular oscillation type powder economizer material has effects of releasing far infrared rays and negative ions, The aforesaid nanotechnical treatment is to cause the powder economizer material to change its material properties and catalytic features so that when the powder economizer material is put into contact with oil molecules, air molecules, or water molecules, each molecule group is diminished and becomes active. When the frequency of the powder economizer material is in conformity with the motion frequency between the molecule groups, resonance and oscillation are produced, thereby enhancing vibration in each molecule and causing a chemical reaction with the oxide materials to enhance oxidation.

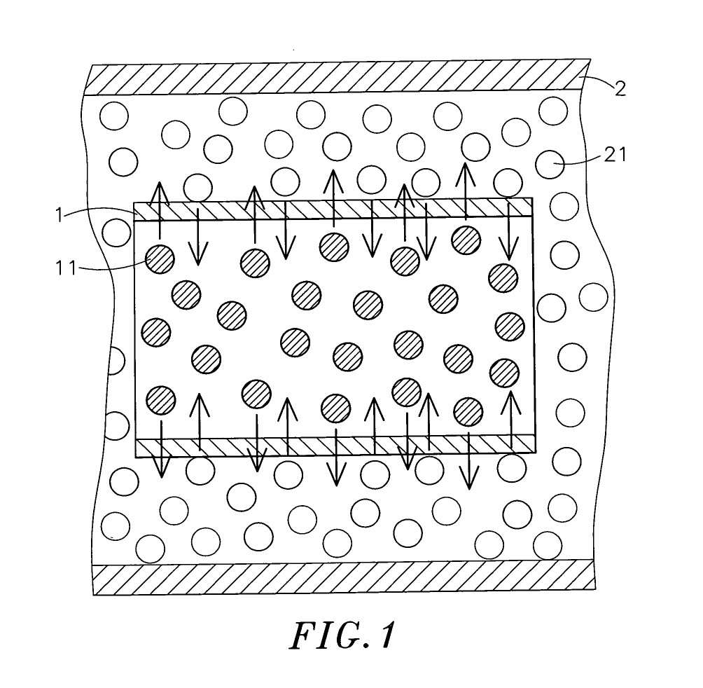

FIG. 1 is a schematic drawing illustration a motion between the powder economizer material of the present invention and oil molecules. When in use, the powder economizer material, referenced by 11, is contained in a nanotechnically treated housing 1, and then the housing 1 carrying the stuffed powder economizer material 11 is mounted inside the oil tank 2 (or auxiliary radiator or air cleaner) of a motor vehicle that carries a fuel oil, for example, heavy fuel oil, biodiesel or ethanol. When the motor vehicle is vibrating during its running, the housing 1 is vibrated with the oil tank 2 to accelerate molecule motion between the powder economizer material 11 in the housing 1 and the oil molecules 21 of the fuel oil in the oil tank 2 (or the air molecules or water molecules in the air cleaner or auxiliary radiator), and therefore the size of the structure of the oil molecules 21 (or air molecules or water molecules) is diminished and the structure of the oil molecules 21 is rearranged so that fuel oil can be fully mixed with air for complete combustion to enhance the horsepower of the engine and to reduce the amount of exhausted waste gas. Therefore, the invention achieves energy saving and air cleaning effects. The housing 1 carrying the powder economizer material 11 may be mounted in the auxiliary radiator or air cleaner

Further, because the powder economizer material 11 of the present invention has the effect of releasing negative ions, it makes oxygen molecules active by causing oxygen molecules to release negative charges. Therefore, the powder economizer material 11 of the present invention enhances oxygen suction, increases the power of oil molecules 21 (or air molecules or water molecules) in oxygen solubilization to effectively reduce micro particles and moisture in air and to excite activeness of air, for enabling oil molecules 21 (or air molecules, or water molecules) to be fully mixed with oxygen for complete combustion.

In general, the technical key points of the powder economizer material 11 of the present invention that improve the prior art designs are as follows:

1. The powder economizer material 11 causes the oil molecules 21 (or air molecules, or water molecules) passing therethrough to rearrange the structure and to separate from hydrocarbon molecules, so that the oil molecules 21 (or air molecules, or water molecules) become smaller for complete combustion in the combustion chamber of the engine to reduce the exhausted amount of carbon monoxide and hydrocarbons, thereby eliminating accumulation of carbon, improving the engine performance and service life, reducing noise level and vibration, saving fuel oil consumption, and reducing production of pollutants.

2. The powder economizer material 11 can cause the molecules of cooling water to diminish the size for transmitting to engine oil when passing through the cylinder, causing engine oil to change its characteristics. Therefore, the size of the molecules of engine oil can be diminished to improve its lubricating effect in protecting the engine and enhancing the sensitivity of the reaction of the accelerator and smoothening the performance of the engine.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A molecular oscillation type powder economizer material comprised of ZnO, SiO₂, CaCO₃, MgO, K₂O, Al₂O₃, rare earth metals, and trace element, said molecular oscillation type powder economizer material emitting far infrared rays and negative ions, said molecular oscillation type powder economizer material causing resonance and oscillation to cause a chemical reaction with oxide materials when put in contact with oil molecules, air molecules and water molecules and when the frequency thereof is in conformity with the motion frequency between molecule groups.

2. The molecular oscillation type powder economizer material as claimed in claim 1, which is contained in a nanotechnically treated housing.
